(19) United States
(12) Patent Application Publication
(10) Pub. No.: US 2003/0145043 A1
(43) Pub. Date: Jul. 31, 2003

(54) Comprehensive system and method for facilitating communication between a supplier and a retailer

(75) Inventor: Carleen Elaine Matuska, Charlotte, NC (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: General Electric Company, Schenectady, NY (US)

(21) Appl. No.: 10/058,956

(22) Filed: Jan. 30, 2002

(51) Int. Cl. G06F 15/16

(52) U.S. Cl. 709/203

(57) ABSTRACT

A comprehensive system and method is provided for facilitating enhanced communication between a supplier and a retailer in an online environment including the step of receiving, from a client computer associated with a supplier, a request to view a home page associated with a retailer. The home page is displayed to the client computer, wherein the home page includes thereon at least the following options: a products option, an issues option, a performance option, and a marketing option. A request is received from the client computer, to select a selected one of the products option, issues option, performance option, and marketing option. Content associated with the selected one of the products option, issues option, performance option, and marketing option is retrieved from at least one server associated with the retailer. The retrieved content is displayed on the client computer.

### BACKGROUND OF THE INVENTION

The present invention relates generally to systems and methods for providing information and related services to users over a computer network. More particularly, the present invention relates to a comprehensive system and method for facilitating communication between a supplier and a retailer in an online environment.

Recent advances in communication, the Internet in particular, have facilitated both the general exchange of information as well as on-line commerce by exposing users to a vast collection of information, vendors and the goods for sale by the vendors. The growth of the Internet over the last several years has been explosive, fueled in the most part by the widespread use of software viewers known as browsers which allow a simple graphical user interface to communicate information electronically between a plurality of different platforms. The Internet has become ubiquitous in businesses and homes because it has proven to be convenient for various applications, such as news and data delivery, conducting banking and investment transactions, and the like.

In addition to simple exchanges of information, the Internet has become a primary vehicle for purchasing goods and services. By enabling users and website operators from geographically remote locations to instantaneously interact, conventional rules relating to sales techniques and customer service are changing by the day. Further, the increased speed at which information is exchanged and deals made has the potential to render markets more efficient. Unfortunately, the vast majority of e-commerce endeavors have focused on the retailer/purchaser relationship. As a result, relationships between suppliers and retailers have not received many of the benefits of online relationships. In particular, exchange of timely, up to date information regarding sales, product inventories, etc. has heretofore not been available to product suppliers, thereby reducing their ability to modify and account for changes in sales.

Therefore, there remains a need in the art of on-line commercial transaction systems for a system which address the deficiencies of present systems in relation to providing services related to facilitating communication between suppliers and retailers in an on-line environment.

### BRIEF SUMMARY OF THE INVENTION

The present invention overcomes the problems noted above, and provides additional advantages, by providing a comprehensive system and method for facilitating enhanced communication between a supplier and a retailer in an online environment including the step of receiving, from a client computer associated with a supplier, a request to view a home page associated with a retailer. The home page is displayed to the client computer, wherein the home page includes thereon at least the following options: a products option, an issues option, a performance option, and a marketing option. A request is received from the client computer, to select a selected one of the products option, issues option, performance option, and marketing option. Content associated with the selected one of the products option, issues option, performance option, and marketing option is retrieved from at least one server associated with the retailer. The retrieved content is displayed on the client computer.

### BRIEF DESCRIPTION OF THE DRAWINGS

The present invention can be understood more completely by reading the following Detailed Description of exemplary embodiments, in conjunction with the accompanying drawings, in which:

FIG. 1 is a block diagram of a computer network suitable for implementing a method and system according to the present invention.

FIG. 2 is a flow chart describing one embodiment of a method for interactively providing enabling enhanced communication between a supplier and a retailer over the network of FIG. 1.

FIG. 3 is a screen shot illustrating one embodiment of the home page described in FIG. 2.

FIG. 4 is a flow chart describing one embodiment of the products option disclosed in FIG. 2.

FIG. 5 is a screen shot of one embodiment of a purchase order web page disclosed in FIG. 4.

FIG. 6 is a flow chart describing one embodiment of the issues option disclosed in FIG. 2.

FIG. 7 is a flow chart describing one embodiment of a method for submitting a new recall in accordance with the method of FIG. 6.

FIG. 8 is a flow chart describing one embodiment of the performance option disclosed in FIG. 2.

FIG. 9 is a flow chart describing one embodiment of the marketing option disclosed in FIG. 2.

### DETAILED DESCRIPTION OF THE INVENTION

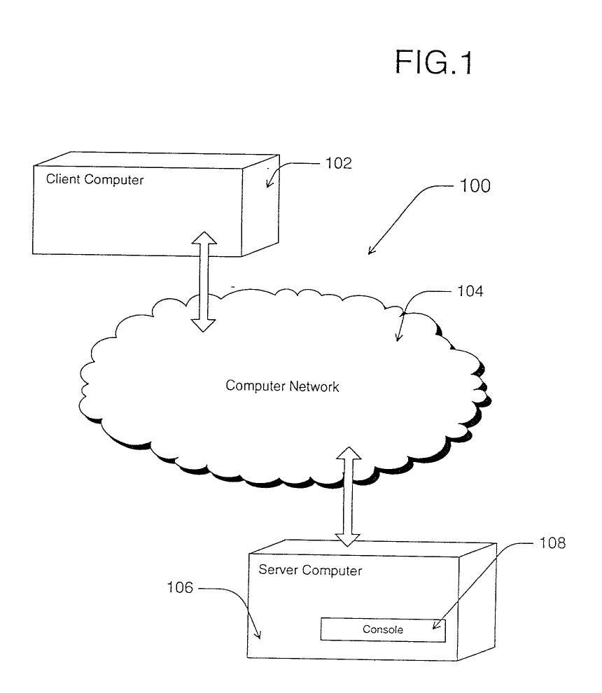

An Internet computer system 100 is generally illustrated in FIG. 1. A conventional client computer system 102, executing a client browser application that supports the HTTP protocol, is connected typically through a network service provider to a suitable computer network 104 such as the Internet.

Client computer system 102 may include, for instance, a personal computer running the Microsoft Windows™ 95, 98, Millenium™, NT™, XP™, or 2000, Windows™CE™, PalmOS™, Unix, Linux, Solaris™OS/2™, BeOS™, MacOS™ or other operating system or platform. Client computer system 102 may also include a microprocessor such as an Intel x86-based device, a Motorola 68K or PowerPC™ device, a MIPS, Hewlett-Packard Precision™ or Digital Equipment Corp. Alpha™ RISC processor, a microcontroller or other general or special purpose device operating under programmed control. Furthermore, client computer system 102 may include electronic memory such as RAM (random access memory) or EPROM (electronically programmable read only memory), storage devices such as a hard drive, CDROM or rewritable CDROM or other magnetic, optical or other media, and other associated components connected over an electronic bus, as will be appreciated by persons skilled in the art. Client computer system 102 may also include a network-enabled appliance such as a WebTV™ unit, radio-enabled Palm™ Pilot or similar unit, a set-top box, a networkable game-playing console such as Sony Playstation™ or Playstation 2™, Microsoft X-Box, Nintendo GameCube, or Sega Dreamcast™, a browser-equipped cellular telephone, or other TCP/IP client or other device.

In addition to the Internet, suitable computer networks may also include or interface with any one or more of, for instance, an local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.92, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, computer network 104 may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. Computer network 104 may yet further include or interface with any one or more of an RS-232 serial connection, an IEEE-1394 (Firewire™) connection, a Fibre Channel connection, an IrDA (infrared) port, a SCSI (Small Computer Systems Interface) connection, a USB (Universal Serial Bus) connection or other wired or wireless, digital or analog interface or connection.

A server computer system 106 is also coupled typically through an Internet Service Provider to the computer network 104. The server computer system 106 may be or include, for instance, a workstation running the Microsoft Windows™ NT™, Windows™ 2000, Windows™ XP™, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. The server computer system 106, controlled by a local console 108, executes at least one web server application conventionally known as a HTTPd server. In addition, the server computer system 106 preferably provides local storage for at least one, though typically many, web pages as files in HTML format and/or other formats. Preferably, a plurality of pricing schedules are also stored in the memory device of server computer system 106. These various pricing schedules are described in additional detail below. Also, server computer system 106 may include several individual server computers at various locations on the network.

The client computer system requests a web page by issuing a URL request through the Internet 104 to the server system 106. A URL consistent with the present invention may be a simple URL of the form:

<protocol_identifier>://<server_path>/<web_page_path>

A “protocol_identifier” of “http” specifies the conventional hyper-text transfer protocol. A URL request for a secure Internet communication session typically utilizes the secure protocol identifier “https,” assuming that the client browser and web server each support and implement the secure sockets layer (SSL). The “server_path” is typically of the form “prefix.domain,” where the prefix is typically “www” to designate a web server and the “domain” is the standard Internet sub-domain.top-level-domain of the server system 106. The optional “web_page_path” is provided to specifically identify a particular hyper-text page maintained by the web server.

In response to a received URL identifying an existing web page, the server system 106 returns the web page, subject to the HTTP protocol, to the client computer system 102. This web page typically incorporates both textural and graphical information including embedded hyper-text links, commonly referred to as hyperlinks, that permit the client user to readily select a next URL for issuance to the computer network 104.

The URL issued from the client system 102 may also be of a complex form that identifies a common gateway interface (CGI) program on a server system 106. Such a HTML hyperlink reference is typically of the form:

<form action=“http://www.vendor.com/cgi-bin/logon.cgi”method=post>

A hyper-text link of this form directs the execution of the logon.cgi program on an HTTP server in response to a client-side selection of the hyperlink. A logon form supported by a logon CGI program is typically used to obtain a client user login name and password to initiate an authenticated session between the client browser and web server for purposes of supporting, for example, a secure purchase transaction or a secure communications session.

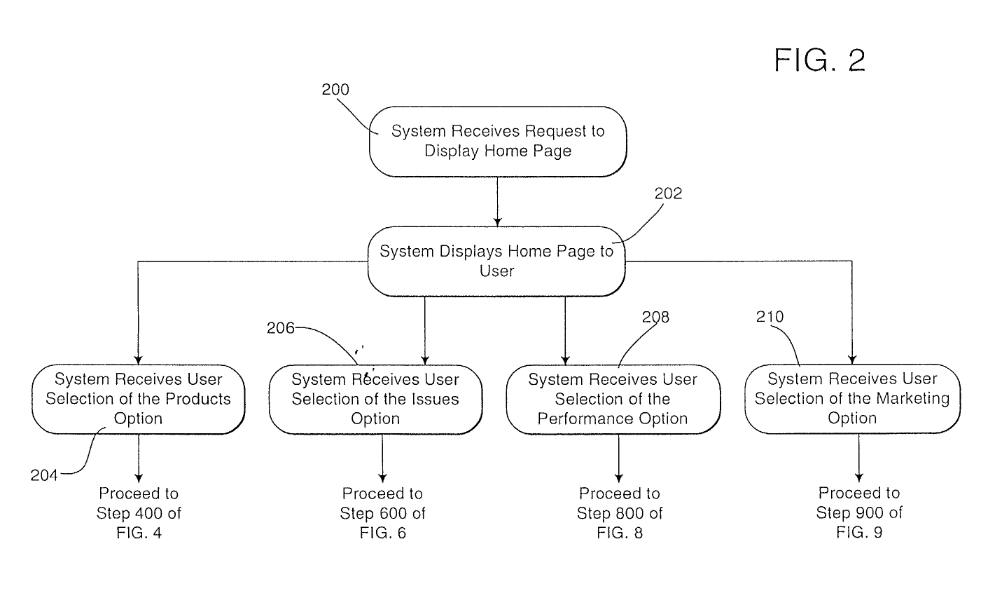

Referring now to FIG. 2, there is shown a flow chart describing one embodiment of a method for interactively enabling enhanced communication between a supplier and a retailer over a computer network. One example of a suitable industry for application of such methodology is the bulk chemical or plastics industry, although the method and system of the present information is adaptable to any industry involving the sale, resale, or consignment of goods. For example, the sheet metal, alloy, and ceramics industries would all particularly benefit from the system and method disclosed herein. It should be understood that, although the preferred embodiment involves an online retailer of goods, the present invention may just as suitably be implemented by a conventional “brick and mortar” retailer to communicate with its suppliers and vendors.

Preferably, the method and system described below is implemented by a computer software program, such as a web server application, resident on one or more server computers (such as server computer system 106, described above) associated with a retailer of goods. Preferably, such a web server application is utilized to create and maintain a plurality of dynamically interactive web pages on the server computer(s). In a preferred embodiment, users of the system, typically associated with suppliers or vendors of the goods being sold, are connected to the server-hosted web pages through the browser applications (e.g., Microsoft Internet Explorer™ and Netscape Navigator®) of a plurality of client computers (such as client computer system 102) over the computer network 104. In this manner, system users may remotely interact with the servers to obtain, exchange, or modify information as more fully set forth in detail below.

Although not limited thereto, computer software programs for implementing the present method may be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

In step 200, the retailer's server computer system (hereinafter generally referred to as “the system”) receives a request from a supplier's client computer system (hereinafter referred to as “the user”) to display a home page which briefly describes the nature of the services and features provided by the system and which includes thereon a plurality of user options, or hyperlinks, the selection of which results in user navigation to the selected content item or site feature.

As is known in the art, a home page is, generally speaking, the first page of a web site, or a collection of related web pages and provides a starting point for enabling a user to navigate through the site in an orderly, user-friendly manner. Accordingly, the present home page is a starting point for the information sharing system of the present invention. In step 202, the system displays the home page on the user's client computer system via the computer network in the manner described above. Following display of the home page, the user may select from a plurality of options related to at least the following general features: 1) product information; 2) product issue and return information; 3) sales performance information; and 4) product marketing information. In addition, several customer service and account administration features are also available to assist users in managing their supplier accounts. It should be understood that these options may be displayed to users on a single web page interface or under discrete web page interfaces corresponding generally to the various site options, respectively. In this manner, any desired level of page simplicity may be obtained.

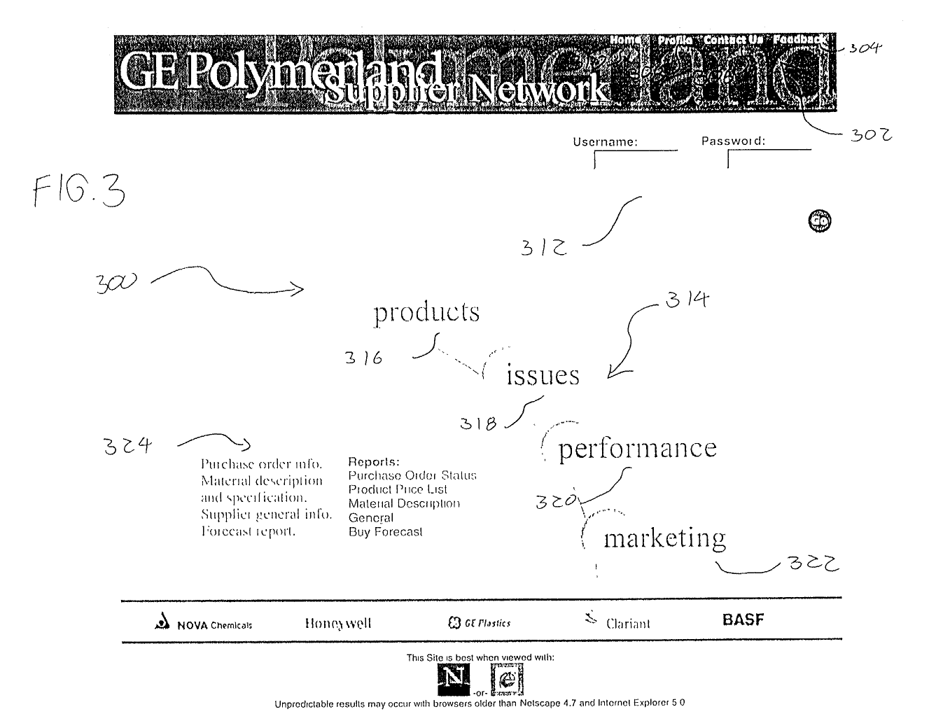

Referring now to FIG. 3, there is shown a screen shot of one embodiment of the home page 300 displayed to the user in step 200. In particular, home page 300 includes a plurality of content areas designed to enable site users to easily navigate to desired areas of the site. A first content area is an administrative content area 302. This area includes various hyperlinks to portions of the site related to site administration and operation, such as a feedback link 304, a contact us link 306 and a profile link 308. In addition, a home link 310 is provided for enabling users to easily return to the home page from anywhere within the site. In a preferred embodiment, the administrative content area 302 is provided on all pages of the website, thereby rendering selection of the provided options more easily accomplished.

A second content area of home page 300 is a login area 312. In this area, users submit there unique username and passwords for access to individualized and confidential portions of the site, which will be described in additional detail below. As is known in the art, upon submission of a proper username/password combination, results in access to information associated with the combination. Further, in one embodiment, upon receipt of proper login information, a new home page is provided, wherein the login content area 312 is replaced with an indication that the user is logged in and an option to log out of the site, to prevent unauthorized access to the information once the user has left the workstation. In an alternative embodiment, login area 312 may also be provided with a “register” or “new user” option, enabling new supplier or suppliers who have not previously set themselves up with the site to register and obtain a username and password combination for full access to the site.

A third content area 314 relates specifically to the functionality which is the subject matter of the present invention. In particular, simple options related to each of the sites core communication objectives are provided for selection by site users. In accordance with the present invention, these options relate to products information 316, issues information 318, sales and issue performance 320, and marketing information 322. Selection of any of the above options results the display of a web page related specifically to the various features associated with each option. In a preferred embodiment, each option 316-322 described above also includes associated ‘mouse-over’ effects. That is, upon receiving an indication that the user has hovered their mouse over a particular option, additional options related to the hovered option are displayed to the user. The user may then select from any of these additional options to more quickly navigate to the desired information. In the embodiment illustrated in FIG. 3, the products option 316 has been moused-over, resulting in the display of the information provided in section 324. It should be understood that, for each option provided, a different set of information is provided in section 324.

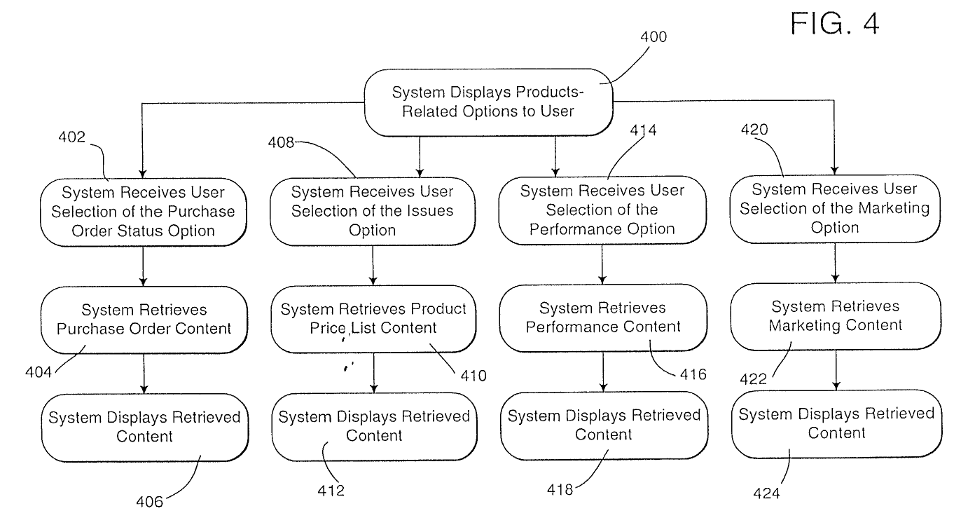

Returning now to FIG. 2, a detailed description of each option will now be set forth below. In step 204, the system receives a user selection of a ‘products’ option 316. Upon receipt of such a request, the system, in one embodiment, proceeds to step 400 of FIG. 4, and displays a product information specific web page to the user. Preferably, the product information page includes at least a listing of all available options related to the various supplier products which the retailer sells. In accordance with the embodiment described above, selection or mouse-over of the product option 316 results in an immediate pop-up display of the various related options, without requiring the loading of an entirely new web page. In one embodiment, such a pop-up display is implemented through the use of javascript technology. The details of various product information options will be described in additional detail below in FIG. 4.

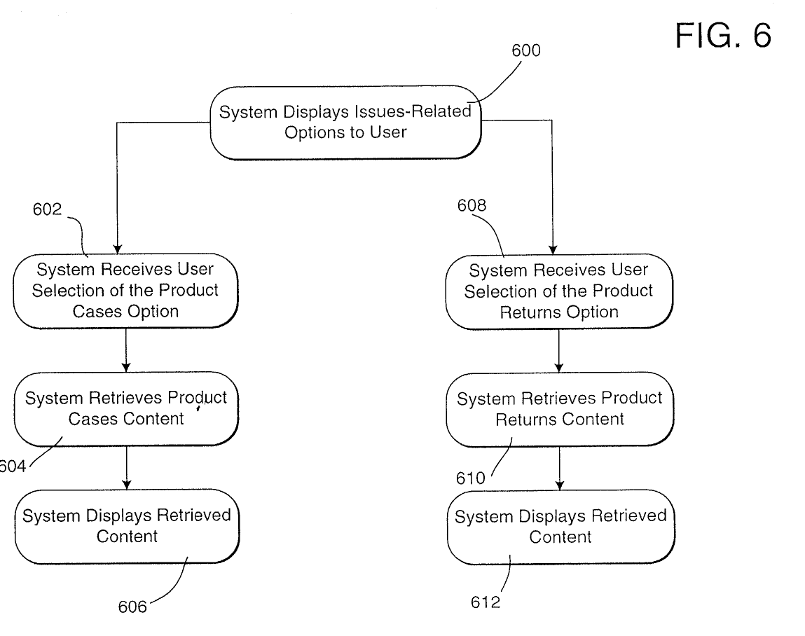

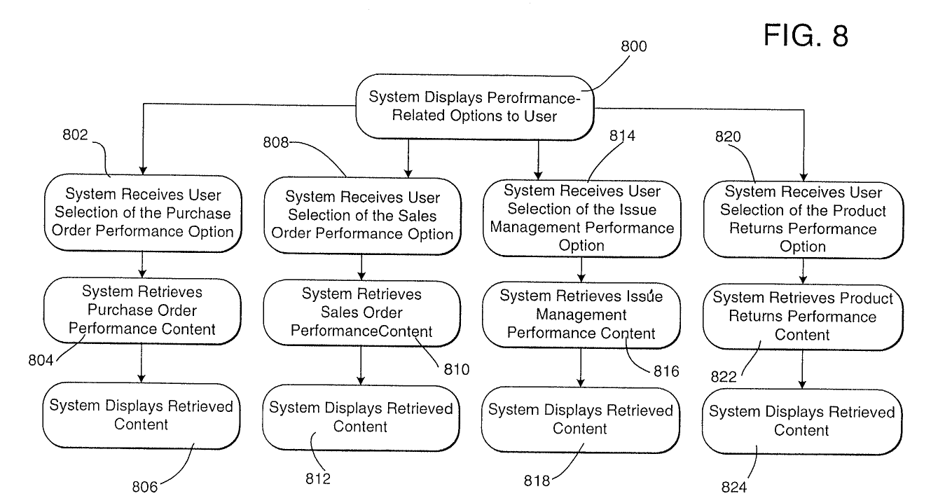

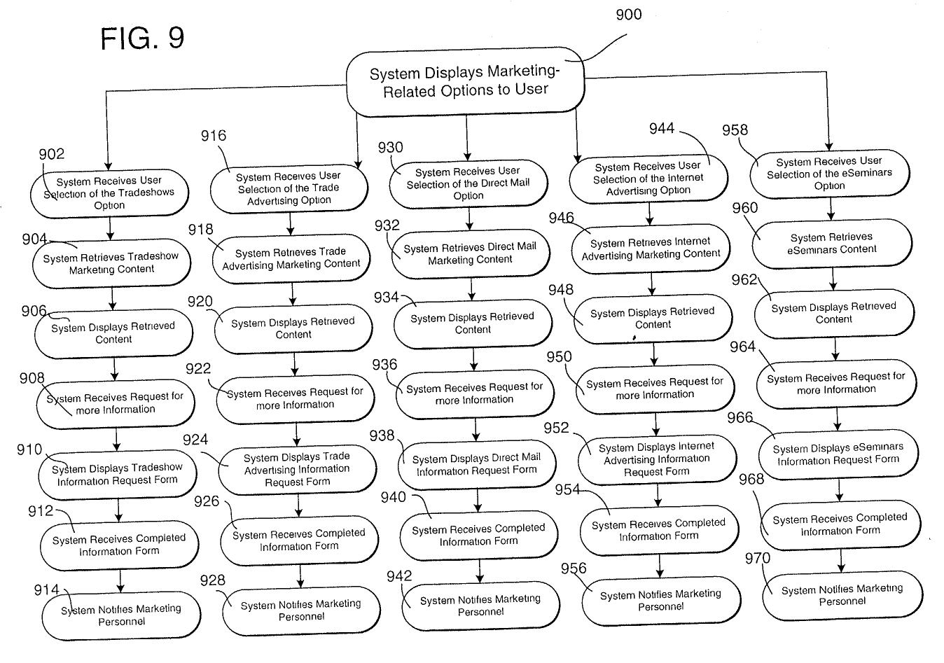

In step 206, the system receives a user selection of the ‘issues’ option 318. Similar to that described above, upon receipt of this selection, the system proceeds to step 600 of FIG. 6, and displays a listing of issue-related options, either in a separate web page or in a pop-up display. The details of the various issue-related options will be described in additional detail below. In step 208, the system receives a user selection of the ‘performance’ option 320. As above, receipt of this selection results in the display of a plurality of performance-related options in step 800 of FIG. 8, more fully described below. In step 210, the system receives a user selection of a ‘marketing’ option 322. In response, the system proceeds to step 900 of FIG. 9, wherein a plurality of product marketing-related options are displayed to the user. Additional details of FIG. 9, will be set forth in additional detail below.

Although each of the above described options are described as stemming from the home page, it should be understood that each of the options may be displayed in such a manner as to be available for user selection from any of the various content pages included within the site. For example, frames technology may be employed, wherein the client's browser display is segmented into various elements, with several of the elements remaining static regardless of user navigation. This technology enables anchoring of the user's experience to the base system options, regardless of particular content element currently being displayed. Alternatively, banner image map technology may be implemented wherein images including hyperlinks are included on each page of the site, thereby providing a similar interface without requiring the implementation of discrete browser frames.

By collectively providing a plurality of services related to the relationship between a retailer in its suppliers over a computer network, the present invention substantially enhances and streamlines the supplier's ability to keep track of its performance and trends. As is understood in the art, the various options available under each of the four major categories may take any suitable form including additional web pages, third party links, java tools, etc. and, although exemplary details of these options will be set forth in detail below, these should not be read as limitations upon the core inventive methodology described herein.

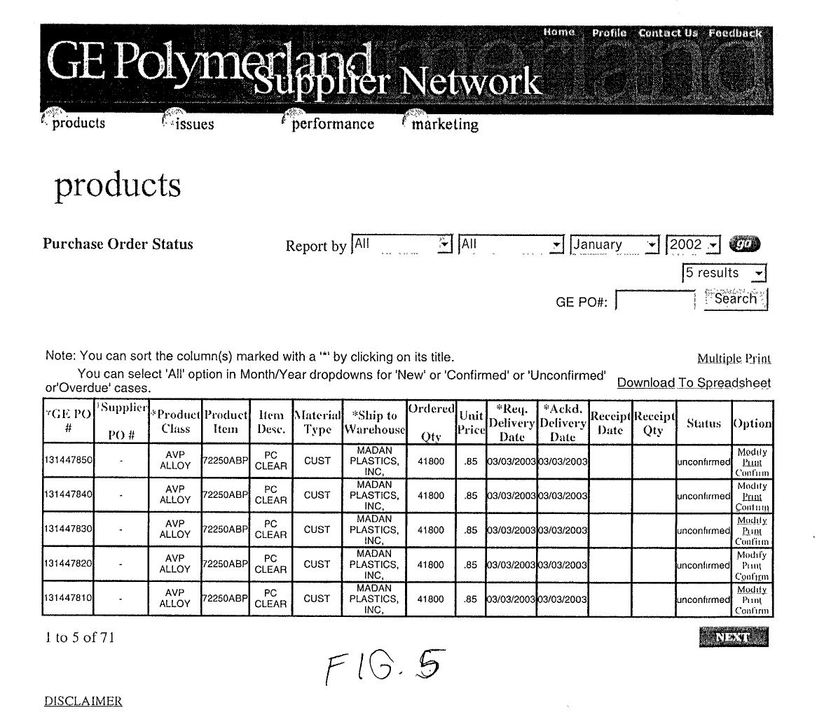

Referring now specifically to FIG. 4, in step 400, the system displays a plurality of products-related options to the user. In one embodiment specifically directed toward the bulk plastics industry, the following options are provided: 1) purchase order status; 2) product price list; 3) material description; 4) general; and 6) buy forecast. In step 402, the system receives a user selection of the purchase order status option. In response, the system, in step 404, retrieves purchase order information from at least one server associated with the system and, in step 406, displays a web page including content related to the various purchase orders maintained by the retailer for the supplier's products. This content preferably includes at least a searchable/sortable table of purchase order information for each of the supplier's products sold by the retailer. In a preferred embodiment, the purchase order information table includes a variety of discrete columns, each relating specifically to a detail of the purchase order in question. FIG. 5 illustrates one embodiment of a purchase order web page including a purchase order table. As shown in FIG. 5, discrete columns may be provided for at least each of the following purchase order criteria: retailer PO#, supplier PO#, product class, material code, shipto warehouse, ordered quantity, price/pound, requested delivery date, acknowledged delivery date, receipt quantity, status and options. Further, the content displayed in the purchase order table shown in FIG. 5 is preferably further modifiable by such criteria as the date, the status, or the product class of the purchase order. In a preferred embodiment, users may chose to display only those purchase orders from a certain date, those which are new confirmed, unconfirmed, closed, and those which are outstanding. Alternatively, users may view all available purchase orders. Further, users may sort the displayed listing of purchase orders by several criteria, including, for example, the supplier's PO#, required delivery date, and acknowledged delivery date. Additionally, in one embodiment, users may search their entire listing of purchase orders for a particular retailer PO#. In a manner well known in the prior art, information presented is associated with the login information provided by the user, thereby ensuring that the user only receives information regarding purchase orders which they are authorized to view.

In a further embodiment of the present invention, users may opt to modify, print or confirm a selected purchase order. Purchase orders which include modifiable terms will be marked accordingly by the presence of the term ‘Modify’ in the options column described above. Upon receiving a user selection of this term for a selected purchase order, the system displays a purchase order modification form, displaying the current details for the selected purchase order and enabling the user to submit a modified details such as unit price, acknowledged delivery date, supplier PO#, etc. Upon receipt of such a modified delivery date, the system updates the associated purchase order information and displays such information upon subsequent request.

In a similar manner, unconfirmed purchase orders may be confirmed by authorized users. Purchase orders which may be confirmed over the website will be marked accordingly by the presence of the term ‘Confirm’ in the options column described above. Upon receiving a user selection of this term for a selected purchase order, the system displays a purchase order confirmation form, displaying the current details for the selected purchase order and enabling the user to submit a modified details such as unit price, acknowledged delivery date, etc. Upon receipt of a completed confirmation form, the system updates the associated purchase order information and displays such information upon subsequent request.

Users may also select to print selected purchase orders. Purchase orders which may be printed over the website will be marked accordingly by the presence of the term ‘Print’ in the options column described above. Upon receiving a user selection of this term for a selected purchase order, the system displays a printer-friendly version of the selected purchase order confirmation form, displaying the current details for the selected purchase order.

In another embodiment of the present invention, an additional ‘multiple print’ option is presented to the users in step 406. Upon receiving a selection of this option, the system displays a date range selection form to the user, enabling the user to submit the dates for which he desires to print the available purchase orders. Upon receipt of a completed date range selection form, the system displays a listing of purchase orders within the selected date range available for printing. The user may then select any or all of the associated purchase orders without requiring additional site navigation.

Returning now to FIG. 4, in step 408, the system receives a user selection of the product price list option. In response, the system, in step 410, retrieves product price list information from a server associated with the system and, in step 412, displays a web page including content related to current prices for the various supplier products sold by the retailer. As with the purchase order content described above, the product price list content also preferably includes at least a listing of the current price for each supplier product currently being sold by the retailer. In an alternative embodiment, this listing is searchable/sortable thereby enabling the user to more easily identify the current price for a particular product. In one embodiment of such a searchable/sortable listing, the supplier's products are listed based upon the market in which they are sold, for example countries, or venues in which the sale takes place.

In step 414, the system receives a user selection of the material descriptions option. In response, the system, in step 416, retrieves material description information for each of the supplier's products which are sold by the retailer. In step 418 this information is displayed to the user, preferably in the form of a searchable/sortable table. In a preferred embodiment, the material description table includes a variety of discrete columns, each relating specifically to a detail of the purchase order in question. Discrete columns may preferably be provided for at least each of the following material description criteria: product class, product item, class description, item description, and material type. Further, the content displayed in the material description table may be further modified based upon the market in which they are sold, for example countries, or venues in which the sale takes place. In a preferred embodiment, users may chose to display only those material description associated with a particular market. Alternatively, users may view all available material descriptions. Further, users may sort the displayed listing of purchase orders by several criteria, including, for example, the product class, the product item, or the material type.

In step 420, the system receives a user selection of the general option. In response, the system, in step 422, retrieves a textual breakdown of the various contract terms existing between the supplier and the retailer. In step 424 this information is displayed to the user, preferably in the form of a web page having a linked index at its top-most portion. A preferred index of general terms includes the following items: Aggregation; Contacts; Color Codes; Cancellation Policy; Direct Shipments; Manufacturing Sites; Minimums; Nomenclature; Pricing Policy; Retailer Buy; Packaging/Repacks; Return Policy; Standard Products; Shipping Policy; Sample Policy; Terms of Contract; and Work Schedule and Calendar. Upon selection of a particular index term, the user will be re-directed to a corresponding portion in the web page describing the details of the supplier/retailer relationship regarding the selected term.

In step 426, the system receives a user selection of buy forecasting report option. In response, the system in step 428 retrieves buy forecast information regarding the various products sold through the retailer. In step 430, the system displays the retrieved buy forecast information to the user, preferably in the form of a searchable/sortable table. In a preferred embodiment, the material description table includes a variety of discrete columns, each relating specifically to a detail of the forecast. Discrete columns may preferably be provided for at least each of the following material description criteria: item description, need date, shipto warehouse, projected order quantity, and projected date of sale. Further, the content displayed in the material description table may be further modified based upon a desired date range for the forecast. Also, users may preferably sort the displayed buy forecast by several criteria, including, for example, the item description, the need date, or the shipto warehouse.

In a preferred embodiment of the present invention, for each of the tables provided under the products option described above an additional option to download the table contents is also provided. For ease of use, the table information is preferably downloadable by the user into a plurality of formats including simple a simple text file (.txt) as well as commonly used spreadsheet files for use in such spreadsheet applications as Microsoft Excel from Microsoft Corporation.

Referring now to FIG. 6, there is shown a flow chart describing one embodiment of a method for providing issue management information to a user. In step 600, the system displays a plurality of issue-related options to the user. In one embodiment, the following options are provided: 1) product cases, relating to any reported product issues; and 2) product returns, relating to supplier-initiated product recalls. In step 602, the system receives a user selection of the product cases option. In response, the system, in step 604, retrieves product case information from at least one server associated with the system and, in step 606, displays a web page including content related to the various product cases maintained by the retailer for the supplier's products. This content preferably includes at least a searchable/sortable table listing each reported product case for a user-defined time period. By default, the present year is displayed, however, this may be easily modified by the user. In a preferred embodiment, the product cases information table includes a variety of discrete columns, each relating specifically to a detail of the product case in question. Discrete columns may preferably be provided for at least each of the following material description criteria: case number, date opened, date closed, product class, product item, lot number, description level, number of days open, and options. Further, the content displayed in the material description table may be further modified based upon the status of the case, whether open or closed. Further, users may sort the displayed listing of product cases by several criteria, including, for example, the case number, the product class, the product item, or the lot number.

In a further embodiment of the present invention, users may opt to respond to a selected open product case over the web site. Product case which are capable of receiving an online response will be marked accordingly by the presence of the term ‘Respond’ in the options column described above. Upon receiving a user selection of this term for a selected product case, the system displays a product case response form, displaying the details for the selected case and enabling the user to submit a instructions relating to the particular issue. Upon receipt of such a case response information, the system automatically notifies an issue response team, via an electronic mail message or the like for expedited resolution of the issue.

In step 608, the system receives a user selection of the product returns option. In response, the system, in step 610, retrieves product returns information from at least one server associated with the system and, in step 612, displays a web page including content related to the various product returns received by the retailer for the supplier's products. This content preferably includes at least a searchable/sortable table listing each returned product for a user-defined time period. By default, the present year is displayed, however, this may be easily modified by the user. In a preferred embodiment, the product returns information table includes a variety of discrete columns, each relating specifically to a detail of the product return in question. Discrete columns may preferably be provided for at least each of the following material description criteria: date of return, retailer return #, supplier PO#, product class, product item, lot number, quantity returned, and return reason code. Users may preferably sort the displayed listing of product returns by several criteria, including, for example, the date of return, the product class, the product item, the lot number, or the return reason code.

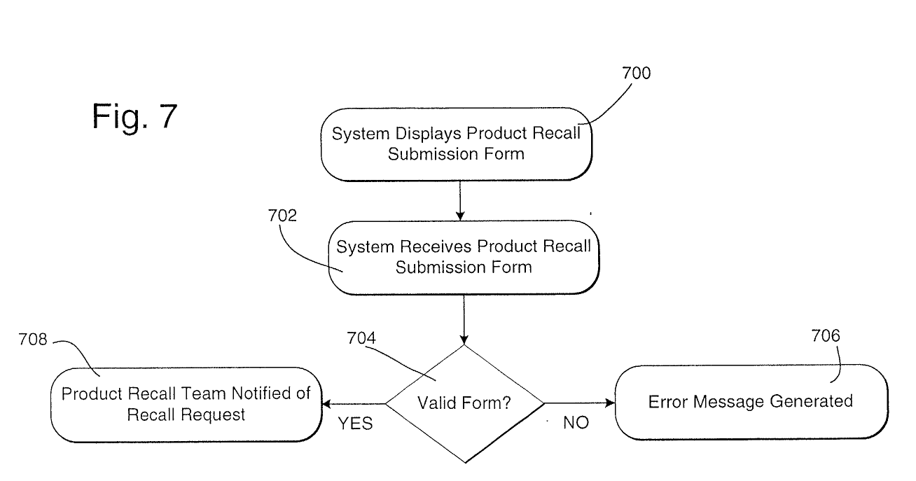

In a further embodiment of the present invention, an additional option is available on the page displayed in step 612. For users wishing to respond to return or return trend by initiating a product recall, a ‘Submit a New Recall’ option is provided. FIG. 7 depicts the operation of this process. Upon receiving a user selection of this option, the system, in step 700, displays a product recall submission form, displaying the fields for user entry of information specific to the desired recall. In particular, the form includes fields relating to the submitter's name, the lot number to be recalled, the ship date of the lot, the shipto location, the shipping pounds, as well as any specific comments which should accompany the recall. Upon receipt of such a product recall submission form in step 702, the system in step 704 automatically determines whether the user has submitted a valid form by identifying the lot number identified in the form. If a valid form has not been submitted, an error message indicating such is displayed to the user in step 706. However, if a valid form has been submitted, the system in step 708 automatically notifies an product recall team, via an electronic mail message or the like for expedited implementation of the requested recall.

Referring now specifically to FIG. 8, in step 800, the system displays a plurality of performance-related options to the user. In one embodiment specifically directed toward the bulk plastics industry, the following options are provided: 1) purchase order performance; 2) sales order performance; 3) issue management performance; and 4) product returns performance. In step 802, the system receives a user selection of the purchase order performance. In response, the system, in step 804, retrieves purchase order performance information from at least one server associated with the system and, in step 806, displays a web page to the user including content related to such performance information. This content preferably includes at least a searchable/sortable table of purchase order performance information for each of the class of the supplier's products sold within a user defined time period. By default this time period is the current month, however, this may be easily modified by the user. In a preferred embodiment, the purchase order performance information table includes a variety of discrete columns, each relating specifically to a detail of the product class performance information in question. Discrete columns may be provided for at least each of the following purchase order performance criteria: product class, total monthly receipt quantity, average monthly performance to request, average monthly performance to acknowledgment, and options.

In a further embodiment of the present invention, users may opt to view specific performance details for a particular product class by selecting a ‘Details’ option in options column described above. Upon receiving a user selection of this term for a selected product class order, the system displays a product class performance information web page, displaying the current details for the selected product class, broken down into individual purchase orders. In a preferred embodiment, the detailed product class performance information includes a sortable table having a variety of discrete columns, each relating specifically to a detail of the purchase order performance information in question. Discrete columns may be provided for at least each of the following purchase order performance criteria: product class, retailer PO#, supplier PO#, product item, shipto warehouse, unit price, receipt quantity, receipt date, requested delivery date, acknowledged delivery date, performance to request, and performance to acknowledgment. Further, the table may be sortable by a variety of criteria including: supplier PO#, product item, shipto warehouse, requested delivery date, or acknowledged delivery date. In a similar manner to that described above, the information contained with the various performance tables may be downloaded for subsequent review and/or analysis.

In step 808, the system receives a user selection of the sales order performance option. In response, the system, in step 810, retrieves sales order performance information from at least one server associated with the system and, in step 812, displays a web page to the user including content related to such performance information. This content preferably includes at least a searchable/sortable table of sales order performance information for each of the class of the supplier's products sold within a user defined time period. By default this time period is the current month, however, this may be easily modified by the user. In a preferred embodiment, the sales order performance information table includes a variety of discrete columns, each relating specifically to a detail of the product class performance information in question. Discrete columns may be provided for at least each of the following purchase order performance criteria: product class, LBS for the month, trend by pounds, and options. Additionally, information is also provided regarding the total LBS for the month and year for all product classes.

In a further embodiment of the present invention, users may opt to view specific sales order performance details for a particular product class by selecting a ‘Details’ option in options column described above. Upon receiving a user selection of this term for a selected product class, the system displays a product class performance information web page, displaying the current details for the selected product class, broken down into individual sales orders. In a preferred embodiment, the detailed product class performance information includes a sortable table having a variety of discrete columns, each relating specifically to a detail of the sales order performance information in question. Discrete columns may be provided for at least each of the following purchase order performance criteria: customer #, customer name, city, state, zip, product item, region, ship date, ship quantity, product class, sales representative, market, and class description. Further, the table may be sortable by a variety of criteria including: customer name, or market. In a similar manner to that described above, the information contained with the various performance tables may be downloaded for subsequent review and/or analysis.

In step 814, the system receives a user selection of the issue management performance. In response, the system, in step 816, retrieves issue management performance information from at least one server associated with the system and, in step 818, displays a web page to the user including content related to such issue management performance information. This content preferably includes at least a searchable/sortable table of issue management performance information for each issue case opened within a user defined time period. By default this time period is the current month, however, this may be easily modified by the user. In a preferred embodiment, the issue management performance information table includes a variety of discrete columns, each relating specifically to a detail of the product class performance information in question. Discrete columns may be provided for at least each of the following criteria: case #, date opened, date closed, customer name, product class, product item, lot #, issue description, and # of days open. Further, the table may be sortable by a variety of criteria including: case #, product class, lot #, or issue description. In a similar manner to that described above, the information contained with the various performance tables may be downloaded for subsequent review and/or analysis.

In step 820, the system receives a user selection of the product returns performance option. In response, the system, in step 822, retrieves product returns performance information from at least one server associated with the system and, in step 824, displays a web page to the user including content related to such product returns performance information. This content preferably includes at least a searchable/sortable table of product returns performance information for each product return made a user defined time period. By default this time period is the current month, however, this may be easily modified by the user.

In a preferred embodiment, the product returns performance information table includes a variety of discrete columns, each relating specifically to a detail of the product class performance information in question. Discrete columns may be provided for at least each of the following criteria: product class, product item, class description, lot #, quantity returned, and return reason code. Further, the table may be sortable by a variety of criteria including: product class, product item, lot #, or return reason code. In a similar manner to that described above, the information contained with the various performance tables may be downloaded for subsequent review and/or analysis.

Referring now specifically to FIG. 9, in step 900, the system displays a plurality of marketing-related options to the user. In one embodiment specifically directed toward the bulk plastics industry, the following options are provided: 1) tradeshows; 2) trade advertising; 3) direct mail; 4) Internet advertising; and 5) eSeminars. In step 902, the system receives a user selection of the tradeshows option. In response, the system, in step 904, retrieves content related to tradeshow marketing from at least one server associated with the system and, in step 906, displays a web page to the user including such tradeshow marketing content. This content preferably includes at least a description of the manner in which the retailer can market the supplier through various tradeshows. Further, the web page displayed in step 906 preferably also includes an option to request additional information regarding tradeshow marketing from the retailer. Upon receipt of a user selection of this option in step 908, a tradeshow information request form is displayed to the user in step 910 and includes various fields wherein the user may indicate their interests and contact information. Upon receipt of a submitted form in step 912, marketing personnel are automatically notified of the supplier's interest in this area for immediate follow up in step 914.

In step 916, the system receives a user selection of the trade advertising option. In response, the system, in step 918, retrieves content related to trade advertising marketing from at least one server associated with the system and, in step 920, displays a web page to the user including such trade advertising marketing content. This content preferably includes at least a description of the manner in which the retailer can market the supplier through various trade advertisements (i.e. journals, etc.). Further, the web page displayed in step 920 preferably also includes an option to request additional information regarding tradeshow marketing from the retailer. Upon receipt of a user selection of this option in step 922, a trade advertising information request form is displayed to the user in step 924 and includes various fields wherein the user may indicate their interests and contact information. Upon receipt of a submitted form in step 926, marketing personnel are automatically notified of the supplier's interest in this area for immediate follow up in step 928.

In step 930, the system receives a user selection of the direct mail option. In response, the system, in step 932, retrieves content related to direct mail marketing from at least one server associated with the system and, in step 934, displays a web page to the user including such direct mail marketing content. This content preferably includes at least a description of the manner in which the retailer can market the supplier through various direct mailings. Further, the web page displayed in step 934 preferably also includes an option to request additional information regarding direct mail marketing from the retailer. Upon receipt of a user selection of this option in step 936, a direct mail information request form is displayed to the user in step 938 and includes various fields wherein the user may indicate their interests and contact information. Upon receipt of a submitted form in step 940, marketing personnel are automatically notified of the supplier's interest in this area for immediate follow up in step 942.

In step 944, the system receives a user selection of the internet advertising option. In response, the system, in step 946, retrieves content related to internet advertising marketing from at least one server associated with the system and, in step 948, displays a web page to the user including such internet advertising marketing content. This content preferably includes at least a description of the manner in which the retailer can market the supplier through various trade advertisements (i.e. journals, etc.). Further, the web page displayed in step 948 preferably also includes an option to request additional information regarding tradeshow marketing from the retailer. Upon receipt of a user selection of this option in step 950, a internet advertising information request form is displayed to the user in step 952 and includes various fields wherein the user may indicate their interests and contact information. Upon receipt of a submitted form in step 954, marketing personnel are automatically notified of the supplier's interest in this area for immediate follow up in step 956.

In step 958, the system receives a user selection of the eSeminars option. In response, the system, in step 960, retrieves content related to eSeminars marketing from at least one server associated with the system and, in step 962, displays a web page to the user including such eSeminars marketing content. This content preferably includes at least a description of the manner in which the retailer can market the supplier through various trade advertisements (i.e. journals, etc.). Further, the web page displayed in step 962 preferably also includes an option to request additional information regarding tradeshow marketing from the retailer. Upon receipt of a user selection of this option in step 964, a eSeminars information request form is displayed to the user in step 966 and includes various fields wherein the user may indicate their interests and contact information. Upon receipt of a submitted form in step 968, marketing personnel are automatically notified of the supplier's interest in this area for immediate follow up in step 970.

By providing a comprehensive system for communicating and sharing information between suppliers and retailers, the present invention substantially improves the manner in which suppliers are kept aware of their product performance and quality issues. Further, by enabling users to research, analyze and investigate all in one coherent environment, the present invention substantially reduces the likelihood of miscommunication between various functions.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

We claim:

1. A method for facilitating communication between a supplier and a retailer in an online environment, comprising the steps of:
receiving, from a client computer associated with a supplier, a request to view a home page associated with a retailer;
displaying the home page to the client computer, wherein the home page includes thereon at least the following options: a products option, an issues option, a performance option, and a marketing option;
receiving a request, from the client computer, to select a selected one of the products option, issues option, performance option, and marketing option;
retrieving, from at least one server associated with the retailer, content associated with the selected one of the products option, issues option, performance option, and marketing option, and
displaying the retrieved content to the client computer.

2. The method of claim 1, further comprising the steps of:
receiving, from the client computer, identification information related the supplier; and
displaying, to the client computer, customized content associated with the selected one of the products option, issues option, performance option, and marketing option, wherein the customized content is retrieved based upon the received identification information.

3. The method of claim 1, further comprising the steps of:
receiving a request from the client computer to select the products option;
displaying, to the client computer, a plurality of products-related options including at least: a purchase order status option, a product price list option, a material description option, a general option, and a buy forecast option;
receiving a request, from the client computer, to select a selected one of the products-related options;
retrieving, from at least one server associated with the retailer, content associated with the selected one of the products-related options, and
displaying the retrieved content to the client computer.

4. The method of claim 3, further comprising the steps of:
receiving a request, from the client computer, to select the purchase order status option;
retrieving, from at least one server associated with the retailer, content associated with the purchase order status option, and
displaying the retrieved content to the client computer,
wherein the content associated with the purchase order status option, comprises at least a sortable table including purchase order information for each of the supplier's products sold by the retailer.

5. The method of claim 4, wherein the sortable table includes at least one of the following discrete columns for each purchase order: retailer PO#, supplier PO#, product class, material code, shipto warehouse, ordered quantity, price per pound, requested delivery, acknowledged delivery date, receipt quantity, and status.

6. The method of claim 4, further comprising the following steps:
receiving, from the client computer, a request to modify a selected purchase order contained within the sortable table;
displaying a purchase order modification form to the client computer for receiving purchase order modification information;
receiving, from the client computer, a completed purchase order modification form; and
updating the content associated with the purchase order option to reflect the modification.

7. The method of claim 6, wherein the purchase order modification information may include: unit price, acknowledged delivery date, or supplier PO#.

8. The method of claim 4, further comprising the following steps:
receiving, from the client computer, a request to confirm a selected purchase order contained within the sortable table;
displaying a purchase order confirmation form to the client computer for receiving purchase order confirmation information;
receiving, from the client computer, a completed purchase order confirmation form; and
updating the content associated with the purchase order option to reflect the modification.

9. The method of claim 3, further comprising the steps of:
receiving a request, from the client computer, to select the product price list option;
retrieving, from at least one server associated with the retailer, content associated with the product price list option, and
displaying the retrieved content to the client computer,
wherein the content associated with the product price option, comprises at least a listing of current price for each supplier product sold by the retailer.

10. The method of claim 3, further comprising the steps of:
receiving a request, from the client computer, to select the material description option;
retrieving, from at least one server associated with the retailer, content associated with the material description option, and
displaying the retrieved content to the client computer,
wherein the content associated with the material description option, comprises at least a sortable table including material description information for each of the supplier's products sold by the retailer.

11. The method of claim 10, wherein the sortable table includes at least one of the following discrete columns for each product: product class, product item, class description, item description and material type.

12. The method of claim 11, wherein the sortable table is sortable by at least one of the following criteria: sales market, product class, product item, and material type.

13. The method of claim 3, further comprising the steps of:
receiving a request, from the client computer, to select the general option;
retrieving, from at least one server associated with the retailer, content associated with the general option, and
displaying the retrieved content to the client computer,
wherein the content associated with the general option, comprises at least a indexed recitation of general terms between the supplier and the retailer.

14. The method of claim 3, further comprising the steps of:
receiving a request, from the client computer, to select the buy forecast option;
retrieving, from at least one server associated with the retailer, content associated with the buy forecast option, and
displaying the retrieved content to the client computer,
wherein the content associated with the buy forecast option, comprises at least a sortable table including buy forecast information for each of the supplier's products sold by the retailer.

15. The method of claim 14, wherein the sortable table includes at least one of the following discrete columns for each product: item description, need date, shipto warehouse, projected order quantity and projected date of sale.

16. The method of claim 15, wherein the sortable table is sortable by at least one of the following criteria: date range, item description, need date, and shipto warehouse.

17. The method of claim 1, further comprising the steps of:
receiving a request from the client computer to select the issues option;
displaying, to the client computer, a plurality of issues-related options including at least: a product cases option, and a product returns option;
receiving a request, from the client computer, to select a selected one of the issues-related options;
retrieving, from at least one server associated with the retailer, content associated with the selected one of the issues-related options, and
displaying the retrieved content to the client computer.

18. The method of claim 17, further comprising the steps of:
receiving a request, from the client computer, to select the product cases option;
retrieving, from at least one server associated with the retailer, content associated with the product cases option, and
displaying the retrieved content to the client computer,
wherein the content associated with the product cases option, comprises at least a sortable table including reported product cases for a user-defined time period.

19. The method of claim 18, wherein the sortable table includes at least one of the following discrete columns for each product case: case number, date opened, date closed, product class, product item, lot number, description level, and number of days open.

20. The method of claim 18, further comprising the steps of:
receiving, from the client computer, a request to respond to a selected one of the product cases listed in the sortable table;
displaying, to the client computer, a product case response form, including therein a variety of fields for receiving instructions relating to the selected product case;
receiving, from the client computer, a completed product case response form; and
automatically notifying an issue response team about the received response form.

21. The method of claim 17, further comprising the steps of:
receiving a request, from the client computer, to select the product returns option;
retrieving, from at least one server associated with the retailer, content associated with the product returns option, and
displaying the retrieved content to the client computer,
wherein the content associated with the product returns option, comprises at least a sortable table including product returns information for a user-defined time period.

22. The method of claim 21, wherein the sortable table includes at least one of the following discrete columns for each product case: date of return, retailer return #, supplier PO#, product class, product item, lot number, quantity returned, and return reason code.

23. The method of claim 21, further comprising the steps of:
receiving, from the client computer, a request to initiate a product recall;
displaying, to the client computer, a product recall submission form, including therein a variety of fields for receiving at least a lot number for the product to be recalled;
receiving, from the client computer, a completed product recall submission form; and
automatically notifying an product recall team about the received recall submission form.

24. The method of claim 23, further comprising the steps of:
determining whether a submitted product recall submission form is valid;
displaying, to the client computer, an error message if it is determined that the submitted product recall submission form is invalid; and
automatically notifying an product recall team about the received recall submission form if it is determined that the submitted product recall submission for is valid.

25. The method of claim 1, further comprising the steps of:
receiving a request from the client computer to select the performance option;
displaying, to the client computer, a plurality of performance-related options including at least: a purchase order performance option, a sales order performance option, a issue management performance option, and a product returns performance option;
receiving a request, from the client computer, to select a selected one of the performance-related options;
retrieving, from at least one server associated with the retailer, content associated with the selected one of the performance-related options, and
displaying the retrieved content to the client computer.

26. The method of claim 25, further comprising the steps of:
receiving a request, from the client computer, to select the purchase order performance option;
retrieving, from at least one server associated with the retailer, content associated with the purchase order performance option, and
displaying the retrieved content to the client computer,
wherein the content associated with the purchase order performance option, comprises at least a sortable table including purchase order performance information for a user-defined time period.

27. The method of claim 26, wherein the sortable table includes at least one of the following discrete columns for each product class: product class, total monthly receipt quantity, average monthly performance to request, and average monthly performance to acknowledgment.

28. The method of claim 26, further comprising the steps of:
receiving, from the client computer, a request to view detailed purchase order performance information for a selected product class;
retrieving, from at least one server associated with the retailer, detailed purchase order performance information for the selected product class, and
displaying the retrieved detailed purchase order performance information to the client computer,
wherein the retrieved detailed purchase order performance information, comprises at least a sortable table including detailed purchase order performance information for each product within the selected product class.

29. The method of claim 25, further comprising the steps of:
receiving a request, from the client computer, to select the sales order performance option;
retrieving, from at least one server associated with the retailer, content associated with the sales order performance option, and
displaying the retrieved content to the client computer,
wherein the content associated with the sales order performance option, comprises at least a sortable table including sales order performance information for a user-defined time period.

30. The method of claim 29, wherein the sortable table includes at least one of the following discrete columns for each product class: product class, LBS for month, and trend by pounds.

31. The method of claim 28, further comprising the steps of:
receiving, from the client computer, a request to view detailed sales order performance information for a selected product class;
retrieving, from at least one server associated with the retailer, detailed sales order performance information for the selected product class, and
displaying the retrieved detailed sales order performance information to the client computer,
wherein the retrieved detailed sales order performance information, comprises at least a sortable table including detailed sales order performance information for each product within the selected product class.

32. The method of claim 25, further comprising the steps of:
receiving a request, from the client computer, to select the issue management performance option;
retrieving, from at least one server associated with the retailer, content associated with the issue management performance option, and
displaying the retrieved content to the client computer,
wherein the content associated with the issue management performance option, comprises at least a sortable table including issue management performance information for a user-defined time period.

33. The method of claim 32, wherein the sortable table includes at least one of the following discrete columns for each product case: case #, date opened, date closed, customer name, product class, product item, lot #, issue description, and # of days open.

34. The method of claim 25, further comprising the steps of:
receiving a request, from the client computer, to select the product returns performance option;
retrieving, from at least one server associated with the retailer, content associated with the product returns performance option, and
displaying the retrieved content to the client computer,
wherein the content associated with the product returns performance option, comprises at least a sortable table including product returns performance information for a user-defined time period.

33. The method of claim 32, wherein the sortable table includes at least one of the following discrete columns for each product return: product class, product item, class description, lot #, quantity returned, and return reason code.

34. The method of claim 1, further comprising the steps of:
receiving a request from the client computer to select the marketing option;
displaying, to the client computer, a plurality of marketing-related options including at least: a tradeshows option, a trade advertising option, a direct mail option, an Internet advertising option, and an eSeminars option;
receiving a request, from the client computer, to select a selected one of the marketing-related options;
retrieving, from at least one server associated with the retailer, content associated with the selected one of the marketing-related options, and
displaying the retrieved content to the client computer.

35. The method of claim 34, further comprising the steps of:
receiving a request, from the client computer, for more information regarding a selected on of the marketing-related options; and
automatically notifying retailer marketing personnel regarding about the received request.
